(19) United States
(12) Patent Application Publication
(10) Pub. No.: US 2005/0259433 A1
(43) Pub. Date: Nov. 24, 2005

(54) Apparatus for manufacturing a vehicular lamp

(75) Inventors: Masahiko Nishizaki, Shizuoka (JP); Haruo Otani, Shizuoka (JP); Fujihiko Sugiyama, Shizuoka (JP); Kazuhiro Yamazaki, Shizuoka (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 10/850,502

(22) Filed: May 20, 2004

(30) Foreign Application Priority Data
May 20, 2004 (JP) P. 2003-141341

(51) Int. Cl. F21V 5/00

(52) U.S. Cl. 362/520

(57) ABSTRACT

An apparatus for manufacturing a vehicular lamp that is formed by a lamp body and a translucent cover welded to the lamp body, the apparatus including a first heating element, which has a heating surface of substantially the same surface shape as the intended welding surface of the translucent cover and extends along the cover's intended welding surface, and a second heating element, which has a heating surface of substantially the same surface shape as the intended welding surface of the lamp body and extends along the lamp body's intended welding surface. The first and second heating elements are made of a resistance heating material.

### BACKGROUND OF THE INVENTION

1. Field of the Invention

The present invention relates to an apparatus for manufacturing a vehicular lamp that welds a translucent cover and a lamp body together by a so-called hot plate welding.

2. Prior Art

Conventionally, hot plate welding has been used for welding a translucent cover and a lamp body of a vehicular lamp.

In the hot plate welding described in, for instance, Japanese Patent Application Laid-Open (Kokai) No. 2001-297608, a translucent cover and a lamp body are welded by first heating the intended welding surfaces of the translucent cover and lamp body of a vehicle using a heating element and then pressing the intended welding surfaces to each other. In this hot plate welding, the heating element is structured such that a cartridge that serves as a heat source is buried in a block-shaped metal member having a heating surface of substantially the same surface shape as the intended welding surfaces of the translucent cover and lamp body.

When the hot plate welding is performed, foaming burr unavoidably generates on both welded surfaces of the translucent cover and lamp body. Such a foaming burr is visible when the welded surfaces are observed from the outside of the lamp through the translucent cover. Accordingly, it is desirable to prevent the generation of foaming burr as much as possible so as to make the foaming burr invisible.

In order to minimize the foaming burr, it is important to heat each of the intended welding surfaces of the translucent cover and lamp body to a predetermined proper welding temperature. For that purpose, it is requested that the heating surface of the metal member be heated up to a predetermined proper heating temperature that corresponds to the proper welding temperature.

However, in the manufacturing apparatus described in Japanese Patent Application Laid-Open (Kokai) No. 2001-297608 described above, a cartridge is buried in the metal member, and the heating surface is indirectly heated by conductive heat that is caused by the heat generation of the cartridge. Accordingly, it takes time to heat the heating surfaces up to the proper heating temperature, and there is a problem that the welding operation efficiency is not satisfactory. In addition, since the heating is indirectly carried out, it is not easy to precisely execute a temperature control of the heating surface. Thus, there is a plenty of room for improvement in minimizing the generation of foaming burr.

### SUMMARY OF THE INVENTION

The present invention is made by taking the above-described circumstances into account.

It is an object of the present invention to provide an apparatus for manufacturing a vehicular lamp that joins a translucent cover and a lamp body together by means of a hot plate welding with an improved welding operation efficiency and with a minimal amount of foaming burr generated.

The present invention accomplishes the above object with an improved heating element.

In particular, the present invention is for an apparatus that manufactures a vehicular lamp formed by heating the intended welding surfaces of the translucent cover and lamp body and then by welding together the translucent cover and the lamp body by way of pressing the intended welding surfaces against each other; and in the present invention:
the apparatus includes a heating element, and this heating element has a heating surface which has substantially the same surface shape as the intended welding surface of the translucent cover or lamp body and extends along the intended welding surface; and
the heating element is made of a resistance heating material that generates heat upon application of electricity.

The “heating element” referred to in the above has a structure in which its heating surface heats up only the intended welding surface of the translucent cover, a structure in which the heating surface heats up only the intended welding surface of the lamp body, or a structure in which one heating surface thereof heats up the intended welding surfaces of the translucent cover and another heating surface thereof heats up the intended welding surface of the lamp body.

Furthermore, the “heating element” is not particularly limited to an element that has a specific structure as far as it is made of a resistance heating material that generates heat when the electric current is applied thereto, and thus it can be a stainless steel such as SUS316 or the like and be an alloy steel such as SCM440 or the like.

As seen from the above, the manufacturing apparatus for vehicular lamps of the present invention is provided with a heating element that has a heating surface, and this heating surface has substantially the same surface shape as the intended welding surface of the translucent cover or of the lamp body and extends along the intended welding surface, and the heating element is made of a resistance heating material that generates heat when the electric current is applied thereto. Accordingly, the heating surface of the heating element is heated up to a proper heating temperature within a short period of time. In addition, since the heating surface of the heating element is directly heated by the heat generated by the heating element, it is possible to make a precise temperature control of the heating surface.

In view of the above, the manufacturing apparatus of the present invention, which is for a vehicular lamp that is structured so that a translucent cover and a lamp body are welded together by hot plate welding, improves the welding operation efficiency and minimizes the generation of foaming burr. In the apparatus of the present invention, the foaming burr generated is small enough and can be hardly conspicuous when the welded surfaces are seen from the outside of the lamp through the translucent cover.

In the manufacturing apparatus of the present invention, the heating element is made of a resistance heating material. Accordingly, it is possible to reduce the electric power consumption by the improvement in the heat efficiency in comparison with the conventional cartridge embedded type heating element, and it is also possible to reduce the manufacturing cost of the heating element and achieve a weight reduction of the heating element.

In the present invention, the specific structure of the heating element is not particularly limited to that described above; and with the use of a heating element that has substantially the same cross section along the entire length, it is possible to heat the entire heating surface substantially evenly, so that a more precise control of the temperature of the heating surface is performed.

In the structure described above, heating of the intended welding surface of the translucent cover or lamp body can be carried out with the heating surface of the heating element abutted with the intended welding surface; however, when heating is carried out in a state that the heating surface of the heating element is positioned near the intended welding surface with a predetermined gap in between, then the apparatus have significant operational effects as follows:

Since the heating surface of the heating element is positioned near the intended welding surface, the intended welding surface is prevented from being deformed since it is not in contact with the heating surface of the heating element; as a result, unexpected large foaming burr is prevented from forming on the translucent cover and lamp body even if a slight dispersion exists in a dimension of the translucent cover and lamp body or even if a dimensional accuracy error exists in the manufacturing apparatus.

Further, when the heating surface of the heating element abuts with the intended welding surface, then it is necessary to periodically apply a surface treatment for promoting a mold release to the heating surface; however, with a setting in which the heating surface of the heating element is in the vicinity of the intended welding surface, the surface treatment described above is not required, and thus the maintenance of the apparatus becomes easier.

In addition, in the case that the heating surface of the heating element abuts with the intended welding surface, a thread-forming phenomenon tends to occur in the intended welding surface when the translucent cover or the lamp body is detached from the heating surface of the heating element. However, by way of positioning or setting the heating surface of the heating element in the vicinity of the intended welding surface, there is no risk that the thread-forming phenomenon occurs; and thus it is possible to avoid defective appearance caused by thread-forming portions left within the lamp chamber of the vehicular lamp after being welded.

The specific size of the “predetermined gap” is not limited to a particular value. It is preferable that the gap be set for 5 mm or less (for example, 0.3 to 3.0 mm or 0.5 to 1.0 mm), so that welding with an improved heat efficiency in a short period of time is accomplished.

Further, in the structure described above, a ceramic coat layer can be provided on the heating surface of the heating element; and this structure provides several advantages as described below.

In particular, the heating element radiates a thermal energy in a wide wavelength distribution upon heat generation; and the wavelength distribution differs depending on the heat generating temperature. On the contrary, the translucent cover and the lamp body which are to be heated are made of a synthetic resin, and thus the thermal energy easily absorbed to these elements is limited to a middle infrared ray wavelength range. On the other hand, ceramics have a behavior that they secondarily radiates a thermal energy by being externally given the thermal energy, and in this case they radiate the thermal energy of a specific infrared ray wavelength range.

Accordingly, by way of providing a ceramic coat layer on the heating surface of the heating element, it is possible to allow the thermal energy of the middle infrared ray wavelength range, which is easily absorbed by the translucent cover and lamp body, to radiate to the intended welding surfaces of the translucent cover and lamp body. As a result, it is possible to further shorten the heating time.

The kind of the ceramics used for the “ceramic coat layer” is not particularly limited. It is preferable to employ ceramics which secondarily-radiates the thermal energy of a wavelength range that has a high absorbability to the translucent cover and the lamp body. More specifically, it is preferable that the ceramic coat layer is constituted by ceramics that radiate infrared ray with a peak wavelength of 2.7 to 3.5 μm upon heat generation.

### BRIEF DESCRIPTION OF THE DRAWINGS

FIGS. 1(a) through 1(c) show the manufacturing steps of a vehicular lamp carried out by the manufacturing apparatus in accordance with one embodiment of the present invention;

FIG. 2 shows, in a perspective view, a part of the manufacturing apparatus;

FIG. 3 shows, in vertical cross-section, the vehicular lamp manufactured by the embodiment of the present invention, the lamp being positioned to face up; and

FIG. 4 is a detailed view of a portion defined by the circle IV in FIG. 3.

### DETAILED DESCRIPTION OF THE INVENTION

Embodiments of to the present invention will be described below with reference to the accompanying drawings.

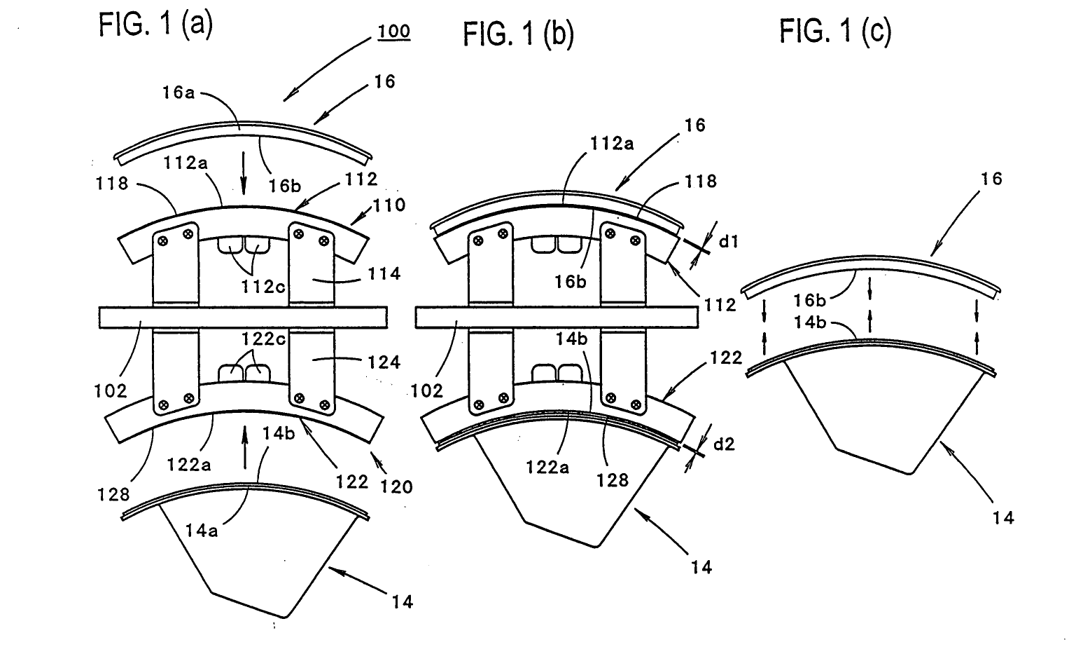

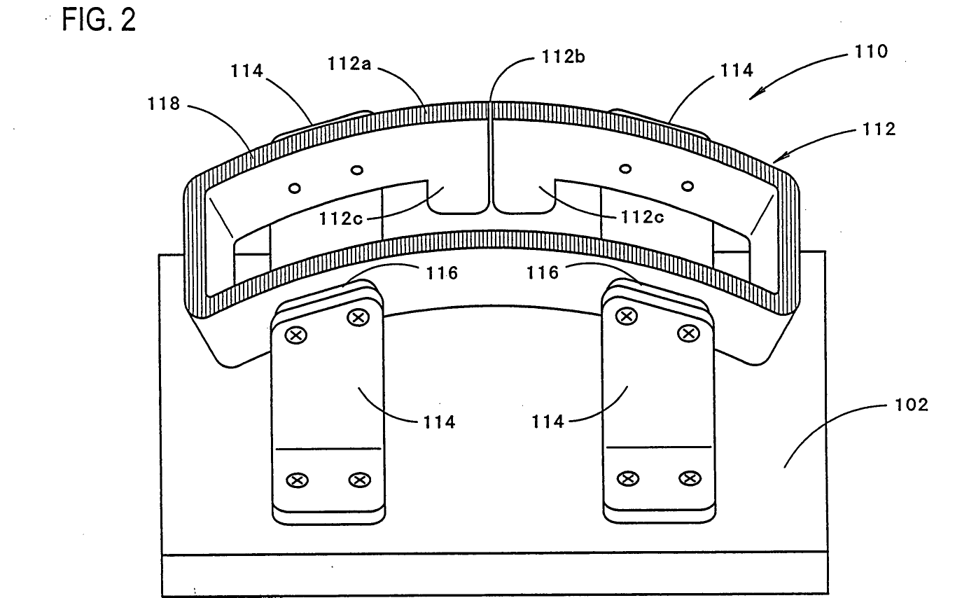

FIGS. 1(a) through 1(c) show the manufacturing process of a vehicular lamp in the manufacturing apparatus of the present invention, and FIG. 2 shows the detail of a part of the manufacturing apparatus.

Before giving a description of the manufacturing apparatus of the shown embodiment of the present invention, a description will be first made on the structure of a vehicular lamp to be manufactured.

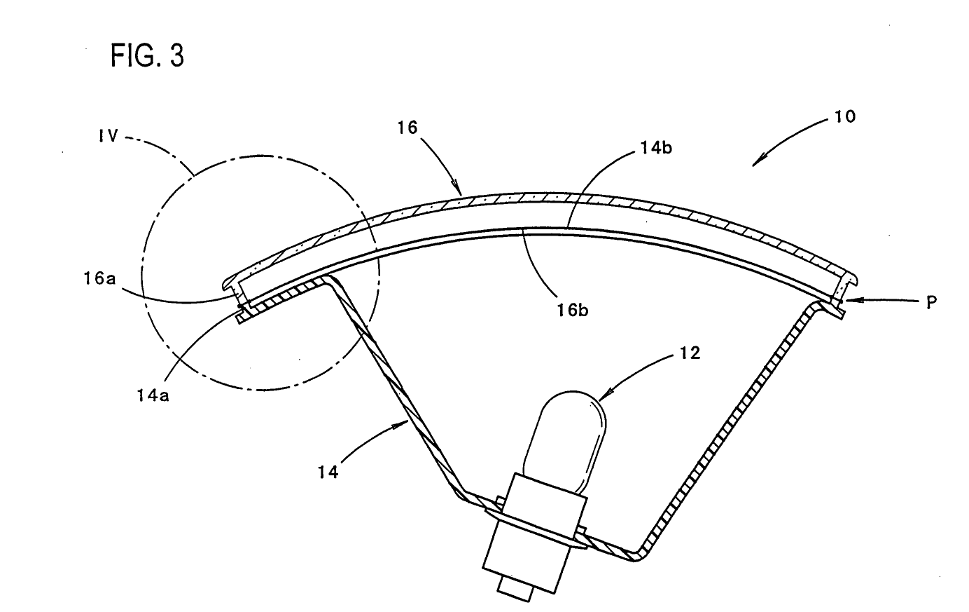

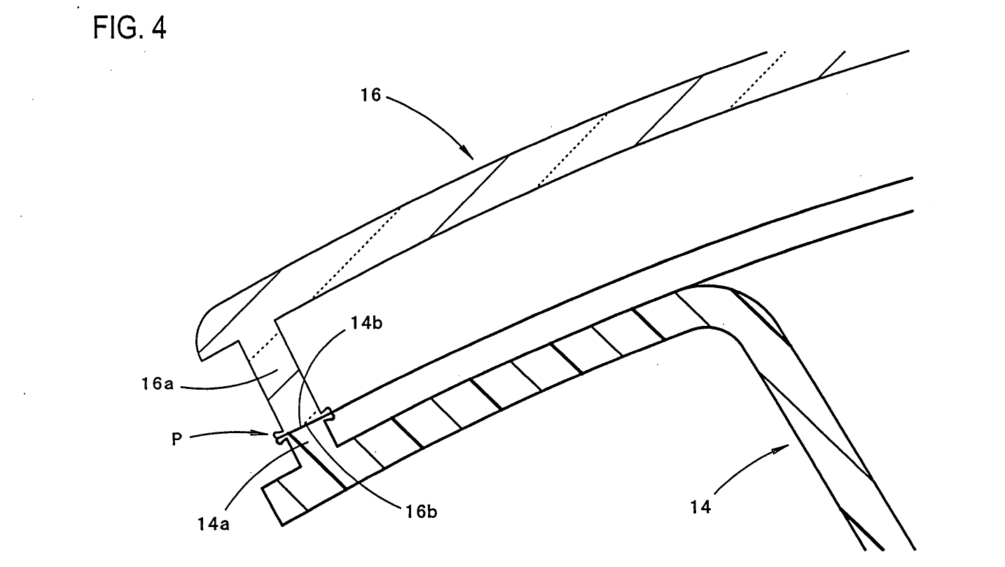

FIG. 3 shows the vehicular lamp that is manufactured by the apparatus of the shown embodiment of the present invention with the lamp set to face upward; and FIG. 4 shows the detail of one part of this lamp.

As seen from FIGS. 3 and 4, a vehicular lamp 10 to be manufactured in the shown embodiment is a marker lamp such as a tail lamp, and it is comprised of a lamp body 14, to which a light source bulb 12 is inserted and attached, and a translucent cover 16, which is welded to the lamp body 14.

The translucent cover 16 is made of a thermoplastic resin material such as PMMA (polymethylmethacrylate), PC (polycarbonate) and the like, and a seal leg 16a protruding to the rear side is formed along the entire outer peripheral edge portion of the cover 16. The translucent cover 16 has a shape that is curved in a substantially circular arc shape in the lateral direction; and, in accordance therewith, the end surface 16b of the seal leg 16a is also curved in a substantially circular arc shape in the lateral direction.

The lamp body 14 is made of a thermoplastic resin material such as AAS (acrylonitrile-acrylic-styrene resin), ABS (acrylonitrile-butadiene-styrene resin) and the like, and a protruding portion 14a that slightly protrudes toward the front is formed at the front end opening along the entire periphery of such opening. The protruding portion 14a is formed so as to positionally correspond to the seal leg 16a of the translucent cover 16, and the end surface 14b of the protruding portion 14a is curved in substantially the same circular shape in the lateral direction as that of the end surface 16b of the seal leg 16a.

The translucent cover 16 and the lamp body 14 are welded together at the end surface 16b of the seal leg 16a of the translucent cover 16 and at the end surface 14b of the protruding portion 14a of the lamp body 14 by a hot plate welding. When hot plate welding is performed, a foaming burr P unavoidably generates on the welded portions of the lamp body 14 and translucent cover 16; however, the foaming burr P is extremely small.

Next, the manufacturing apparatus of the present invention will be descried below.

As seen from FIGS. 1 and 2, the manufacturing apparatus 100 is for welding the translucent cover 16 and the lamp body 14 together, and it is comprised of upper and lower heating units 110 and 120 that make a pair and are provided above and below the supporting plate 102 that is disposed horizontally.

More specifically, in this manufacturing apparatus 100, the entire end surface 16b of the seal leg 16a which will be the intended welding surface of the translucent cover 16 is heated by the upper heating unit 110, and the entire end surface 14b of the protruding portion 14a which will be the intended welding surface of the lamp body 14 is heated by the lower heating unit 120; and after heating, both intended welding surfaces 16b and 14b are pressed against each other, so that the translucent cover 16 and the lamp body 14 are joined to make a single unit.

The upper heating unit 110 is disposed above the supporting plate 102 and is comprised of a heating element 112 for heating the intended welding surface 16 of the translucent cover 16, a plurality of supporting brackets 114 on which the heating element 112 is provided, and insulation members 116 interposed between the respective supporting brackets 114 and the heating element 112.

The heating element 112 of the upper heating unit 110 has a heating surface 112a. The heating surface 112a has substantially the same surface shape as the intended welding surface 16b of the seal leg 16a of the translucent cover 16 and is larger in width than the end surface 16b; and in addition, it extends annularly along the end surface 16b. The heating element 112 has substantially the same cross section for the entire length of the heating surface 112a, and a slit 112b is formed in one position in the peripheral direction.

Furthermore, the heating element 112 is formed by a resistance heating material (for example, a stainless steel such as SUS316 or the like, an alloy steel such as SCM440 or the like) that generates heat when electric current is applied thereto, and a ceramic coat layer 118 is provided on the heating surface 112a. Further, portions on both sides of the slit 112b in the heating element 112 protrude downward and form a pair of terminal portions 112c. Power (electricity) feeding to the heating element 112 is carried out at the terminal portions 112c.

On the other hand, the lower heating unit 120 disposed below the supporting plate 102 is, like the upper heating unit 110, comprised of a heating element 122 for heating the intended welding surface 14 of the lamp body 14, a plurality of supporting brackets 124 on which the heating element 122 is provided, and insulation members (not shown) interposed between the respective supporting brackets 124 and the heating element 122.

The heating element 122 of the lower heating unit 120 has a heating surface 122a. The heating surface 122a has substantially the same surface shape as the intended welding surface 14b of the protruding portion 14a of the lamp body 14 and is larger in width than the end surface 16b; and in addition, it extends annularly along the end surface 16b. The heating element 122 has substantially the same cross section for the entire length of the heating surface 122a, and a slit (not shown but substantially the same as the slit 112 of the upper heating unit 110) is formed in one position in the peripheral direction.

Furthermore, the heating element 122 is formed by a resistance heating material (for example, a stainless steel such as SUS316 or the like, an alloy steel such as SCM440 or the like) that generates heat when electric current is applied thereto, and a ceramic coat layer 128 is provided on the heating surface 122a. In addition, portions on both sides of the above-described slit in the heating element 122 protrude upward and form a pair of terminal portions 122c. Power (electricity) feeding to the heating element 122 is carried out at the terminal portions 122c.

The ceramic coat layers 118 and 128 of the respective heating elements 112 and 122 are structured by ceramics (for example, Si oxide, Al oxide or the like) that radiate an infrared ray having a peak wavelength of 2.7 to 3.5 μm upon heat generation. The ceramic coat layers 118 and 128 are formed by a ceramic thermal spraying method and has a thickness of 0.5 to 3.0 mm.

Next, the hot plate welding process for joining the translucent cover 16 and the lamp body 14 together by the manufacturing apparatus 100 described above will be described.

Firstly, in FIG. 1(a), the heating element 112 is heated by supplying electricity to the heating element 112 of the upper heating unit 110 so that the heating surface 112a becomes about 600° C., and the heating element 122 is likewise heated by supplying electricity to the heating element 122 of the lower heating unit 120 so that the heating surface 122a becomes about 600° C. At the same time, the translucent cover 16 is held above the upper heating unit 110 by a cover holding fixture (not shown), and the lamp body 14 is held below the lower heating unit 120 by a lamp body holding fixture (not shown).

Next, as shown in FIG. 1(b), the translucent cover 16 is lowered so as to be brought in the vicinity of the heating surface 112a of the heating element 112, and the lamp body 14 is likewise raised and brought in the vicinity of the heating surface 122a of the heating element 122. In this process, a gap dl between the heating surface 112a of the heating element 112 and the intended welding surface 16b of the translucent cover 16 is set to be about a value satisfying the relation 0.5<d1<1.0 mm, and a gap d2 between the heating surface 122a of the heating element 122 and the intended welding surface 14b of the lamp body 14 is likewise set to be about a value satisfying the relation 0.5<d2<1.0 mm.

The above described state, in which the translucent cover 16 is in the vicinity of the heating surface 112a of the heating element 112 and the lamp body 14 is in the vicinity of the heating surface 122a of the heating element 122 with a gap d1 and d2, respectively, is kept for about 10 to 15 seconds. As a result, the areas near the intended welding surface 16b in the seal leg 16a of the translucent cover 16 and the areas near the intended welding surface 14b in the protruding portion 14a of the lamp body 14 are heated by the thermal energy of the infrared ray that is radiated from the heating elements 112 and 122 via the ceramic coat layers 118 and 128, so that such areas are softened and melted.

Thereafter, the translucent cover 16 is raised and the lamp body 14 is lowered, and the manufacturing apparatus 100 is removed from between the translucent cover 16 and the lamp body 14.

Finally, the intended welding surface 16b of the translucent cover 16 and the intended welding surface 14b of the lamp body 14 are pressed against each other as shown in FIG. 1(c); as a result, the intended welding surfaces 16b and 14b of the translucent cover 16 and lamp body 14 are securely welded together.

As described above in detail, the apparatus 100 of the shown embodiment which is for manufacturing vehicular lamps includes the heating element 112 and the heating element 122; the heating element 112 is provided with the heating surface 112a that has substantially the same surface shape as the intended welding surface 16b of the translucent cover 16 and extends along the intended welding surface 16b, and the heating element 122 is provided with the heating surface 112a that has substantially the same surface shape to the intended welding surface 14b of the lamp body 14 and extends along the intended welding surface 14b; and these heating elements 112 and 122 are made of a resistance heating material that generates heat upon application of electricity thereto.

Accordingly, it is possible to heat the heating surfaces 112a and 122a to a proper heating temperature within a short time and improve the welding operation efficiency. In addition, since the heating surfaces 112a and 122a of the respective heating elements 112 and 122 are directly heated by the heat of the heating elements, the temperature of the heating surfaces 112a and 122a can be precisely controlled, and the generation of foaming burr can be minimized.

In other words, as seen from FIG. 4, in the vehicular lamp 10 in which the welding between the translucent cover 16 and the lamp body 14 is completed by the hot plate welding process described above, the foaming burr P generates on both sides of the welded surfaces between the seal leg 16a of the translucent cover 16 and the protruding portion 14a of the lamp body 14. However, this foaming burr P generates at the time of pressing of the translucent cover 16 and the lamp body 14 against each other, and its protruding amount is extremely small. Accordingly, the foaming burr P is small enough and is hardly conspicuous when the welded surfaces are observed from the outside of the lamp through the translucent cover 16.

Further, in the manufacturing apparatus 100 described above, the heating elements 112 and 122 are made of a resistance heating material. Accordingly, it is possible to reduce the electric power consumption by an improvement in the heat efficiency in comparison with the conventional cartridge embedded type heating element, and it is also possible to reduce the manufacturing cost and to achieve a weight reduction of the heating elements 112 and 122.

In the shown embodiment, since the respective heating elements 112 and 122 are formed in substantially the same cross section for the entire length of the heating surfaces 112a and 122a, it is possible to uniformly heat each of the entire heating surfaces 112a and 122a, thus allowing a precise control of the temperature of each of the heating surfaces 112a and 122a to be done.

Furthermore, in the above embodiment, heat is applied to the intended welding surfaces 16b and 14b of the translucent cover 16 and lamp body 14 in such a manner that the heating surfaces 112a and 122a of the heating elements 112 and 122 are set near the intended welding surfaces 16b and 14b with predetermined gaps in between. Accordingly, the following advantages are assured:

Since the heating surfaces 112a and 122a of the heating elements 112 and 122 are, during the heating, positioned near the intended welding surfaces 16b and 14b, even if a slight dispersion exists in the dimension of the translucent cover 16 and lamp body 14 or even if a dimensional accuracy error exists in the manufacturing apparatus 100, unexpected large foaming burr, which tends to generate if the intended welding surfaces 16b and 14b are in contact with the heating surfaces 112a and 122a and deform by the heat, is prevented.

In addition, it is, in the present invention, not necessary to execute surface treatment for promoting mold release which is periodically carried out in an apparatus in which heating surfaces of heating elements are brought into contact with intended welding surfaces; accordingly, maintenance of the apparatus is easy in the present invention. Further, since there is no risk of thread-forming phenomenon that would occur in a case where heating surfaces of the heating elements are brought into contact with intended welding surfaces, a defective appearance of the lamp that is caused by the thread-forming portion left within the lamp chamber of a vehicular lamp after welding is prevented.

In the shown embodiment, since the gaps d1 and d2 between the intended welding surfaces 16b and 14b and the heating surfaces 112a and 122a of the heating elements 112 and 122 is set to be 0.5 to 1.0 mm at the time of execution of heating on each of the intended welding surfaces 16b and 14b, welding can be performed efficiently within a short time.

Further, in the above embodiment, the ceramic coat layers 118 and 128 are provided on the heating surfaces 112a and 122a of the heating elements 112 and 122, respectively. Accordingly, the thermal energy of the middle infrared ray wavelength area, which can be easily absorbed by the translucent cover 16 and lamp body 14, is radiated to the intended welding surfaces 16b and 14b of the translucent cover 16 and the lamp body 14, and the heating time can be shortened accordingly.

More specifically, since the ceramic coat layers 118 and 128 of the respective heating elements 112 and 122 are made of ceramics that, when heated, radiates infrared ray that has a peak wavelength of 2.7 to 3.5 μm, several operational effects as described below can be obtained.

In particular, though the wavelength distribution of the thermal energy radiated from the heating elements 112 and 122 changes depending on the heat generating temperature, since the thermal energy is secondarily radiated from the surfaces of the ceramic coat layers 118 and 128 in accordance with the wavelength distribution that has the peak of the middle infrared ray (an informed ray that has a wave length of 2.7 to 3.5 μm) which is easily absorbed by the synthetic resin translucent cover 16 and lamp body 14, it is possible to improve the thermal energy absorption efficiency of the translucent cover 16 and the lamp body 14.

In addition, in the shown embodiment, the ceramic coat layers 118 and 128 are formed by a ceramic thermal spraying method. Accordingly, it is possible to set the thickness of the ceramic coat layers 118 and 128 to be small, so that the heating effect caused by the adiabatic effect of the ceramic coat layers 118 and 128 is not lowered, and the generation of cracks is prevented. Further, even though the surface shapes of the heating surfaces 112a and 122a of the heating elements 112 and 122 are curved (or three-dimensionally changed), the ceramic coat layers 118 and 128 can be easily formed by the ceramic thermal spraying method.

In the above description, the proper heating temperatures of the heating elements 112 and 122 are about 600° C. However, naturally, the proper heating temperatures can be set to different temperatures depending upon the material or the like of the translucent cover 16 and lamp body 14 which are to be heated.

In addition, the embodiment above is described on the vehicular lamp 10 which is a marker lamp. However, the same operational effects as those described above can be obtained by employing the same structure as that of the embodiment described above for the other kinds of vehicular lamps.

1. An apparatus for manufacturing a vehicular lamp comprised of a translucent cover and a lamp body that are welded together, the welding being carried out by heating intended welding surfaces of the translucent cover and lamp body and then pressing the intended welding surfaces against each other, wherein
said apparatus includes a heating element having a heating surface which has substantially the same surface shape as the intended welding surface of the translucent cover or the intended welding surface of the lamp body and extends along the intended welding surface; and
said heating element is made of a resistance heating material that generates heat upon application of electricity thereto.

2. The apparatus according to claim 1, wherein said heating element has substantially the same cross section along an entire length of the heating surface of said heating element.

3. The apparatus according to claim 1, wherein heating is carried out with the heating surface of said heating element positioned near the intended welding surface with a gap in between.

4. The apparatus according to claim 2, wherein heating is carried out with the heating surface of said heating element positioned near the intended welding surface with a gap in between.

5. The apparatus according to claim 3, wherein a ceramic coat layer is provided on the heating surface of said heating element.

6. The apparatus according to claim 4, wherein a ceramic coat layer is provided on the heating surface of said heating element.
